(19) United States
(12) Patent Application Publication
(10) Pub. No.: US 2026/0359768 A1
(43) Pub. Date: Nov. 12, 2026

(54) IDENTIFYING NATURE-RELATED IMPACTS OF ORGANIZATIONS

(71) Applicant: International Business Machines Corporation, Armonk, NY (US)

(72) Inventors: Fearghal O'DONNCHA, Galway (IE); Adam James THOMPSON, Bayern (DE); Johannes Moritz STÄBLER, Köln (DE); Andrew James STANFORD-CLARK, Isle of Wight (GB)

(21) Appl. No.: 19/201,156

(22) Filed: May 7, 2025

(51) Int. Cl. G06Q 10/067; G06Q 10/04; G06Q 50/02

(52) U.S. Cl. CPC G06Q 10/067; G06Q 10/043; G06Q 50/02

(57) ABSTRACT

A server identifies metrics associated with operations of an organization. The server identifies nature-related data associated with an ecosystem. The server provides the metrics and the nature-related data to a model. The server determines, based on the model, a nature-related impact of the organization, wherein the nature-related impact is based on a causal attribution that attributes a variation in the nature-related data to the operations of the organization. The server generates a report that indicates the nature-related impact of the organization.

### BACKGROUND

This disclosure relates to computer systems for analyzing nature-related impacts, and more specifically, to identifying nature-related impacts of organizations.

### SUMMARY

Some aspects described herein relate to a method. The method may include identifying metrics associated with operations of an organization. The method may include identifying nature-related data associated with an ecosystem. The method may include providing the metrics and the nature-related data to a model. The method may include determining, based on the model, a nature-related impact of the organization, where the nature-related impact is based on a causal attribution that attributes a variation in the nature-related data to the operations of the organization. The method may include generating a report that indicates the nature-related impact of the organization.

Some aspects described herein relate to a computer system. The computer system may include a processor set, one or more computer-readable storage media, and program instructions stored on the one or more computer-readable storage media to cause the processor set to perform operations. The operations may include identifying metrics associated with operations of an organization. The operations may include identifying nature-related data associated with a marine ecosystem. The operations may include determining, using a model, a nature-related impact of the organization based on the metrics and the nature-related data, where the nature-related impact is based on a causal attribution that attributes a variation in the nature-related data to the operations of the organization. The operations may include generating a report that indicates the nature-related impact of the organization.

Some aspects described herein relate to a computer program product. The computer program product may include one or more computer-readable storage media and program instructions stored on the one or more computer-readable storage media to perform operations. The operations may include identifying metrics associated with operations of an organization. The operations may include identifying nature-related data associated with a marine ecosystem. The operations may include determining a nature-related impact of the organization based on the metrics and the nature-related data, where the nature-related impact is based on a causal attribution that attributes a variation in the nature-related data to the operations of the organization. The operations may include generating an output associated with the nature-related impact of the organization.

### BRIEF DESCRIPTION OF THE DRAWINGS

FIG. 1 is a diagram of an example computing environment for identifying nature-related impacts of organizations.

FIG. 2 is a diagram illustrating an example associated with identifying nature-related impacts of organizations.

FIG. 3 is a diagram illustrating an example associated with essential biodiversity variables.

FIG. 4 is a diagram illustrating an example associated with mapping essential ocean variables and essential biodiversity variables.

FIG. 5 is a diagram illustrating an example associated with causal attribution.

FIG. 6 is a flowchart of an example process associated with identifying nature-related impacts of organizations.

### DETAILED DESCRIPTION

The following detailed description of example implementations refers to the accompanying drawings. The same reference numbers in different drawings may identify the same or similar elements.

Organizations may conduct operations that have an impact on the natural world. A taskforce on nature-related financial disclosures (TNFD) may encourage organizations to assess and disclose their impacts on the natural world. Such impacts may include biodiversity loss, deforestation, and pollution. The TNFD may especially encourage organizations to assess and disclose their impacts to oceans due to their critical role in biodiversity, climate regulation, and ecosystem services. Such impacts on the oceans may include biodiversity loss, ocean acidification, and rising sea levels.

However, organizations may not have an appropriate methodology to calculate and report nature-related impacts. Existing methodologies for reporting nature-related impacts may be highly manual and lack standardization across different realms and biomes of nature. Deficiencies associated with the existing methodologies makes it difficult to compare and contrast data across different sectors and organizations, thereby hindering the development of effective strategies to mitigate nature-related risks. The scale and complexity of the assessment and reporting of nature-related impacts may be exacerbated by the sparse and fragmented nature of ocean observation systems, a lack of usability of satellite data, and a large number of manners in which industries may impact oceans. As a result, organizations may waste an inordinate amount of resources, such as compute resources and network resources, to calculate and report nature-related impacts. Due to variance across different sectors and organizations, such calculating and reporting may have to be repeated multiple times, further wasting resources, thereby degrading an overall system performance.

In some implementations, a server may be capable of quantifying the impacts of industry operations on the ocean. The server may determine, using causal discovery, a causal relationship between variations in ocean data and specific activities of a given organization. The ocean data may be related to a plurality of ocean biomes and the activities may be part of the organization's operations. The server may quantify, based on the causal relationship, the impacts of the organization's operations on the ocean. In some implementations, the server may perform a sectoral assessment to identify the ocean biomes and the organization's operations that impact such ocean biomes. The server may collect data on the ocean biomes and the organization's operations from a plurality of data sources. The server may transform the data into a format suitable for analysis. The server may store the transformed data in a database. In some implementations, the server may simulate different operational conditions to generate reporting metrics and uncertainty on the identified activities and address data gaps. The server may provide, based on the metrics, a summary of the nature-related impact of the organization on the ocean biomes.

In some implementations, the server may determine, using causal discovery, a causal relationship between variations in ocean data and specific activities of a given organization. The ocean data may be related to a plurality of ocean biomes and the activities may be part of the organization's operations. The server may quantify, based on the causal relationship, the impacts of the organization's operations on the ocean. The server, to determine the causal relationship, may identify patterns in the ocean data and the organization's operations. The server may identify the patterns using machine learning. The server may attribute, using statistical models, the variations in the ocean data to the specific activities of the organization.

In some implementations, the server may perform a sectoral assessment to identify the ocean biomes and the organization's operations that impact the ocean biomes. The server, to perform the sectoral assessment, may extract metrics on the organization's operations and map the metrics to a standardized template. The server may identify, based on the standardized template, the ocean biomes and the organization's operations that impact the ocean biomes. In some implementations, the server may collect data on the ocean biomes and the organization's operations from a plurality of data sources. The server may transform the data into a format suitable for analysis. The server may store the transformed data in a database. In some implementations, the server may simulate different operational conditions to generate reporting metrics and uncertainty on the identified activities and address data gaps.

In some implementations, the server, to quantify the impacts of the organization's operations, may calculate a score representing the degree of impact of the organization's operations on the ocean biomes. The server may calculate the score based on the causal relationship. The server may provide, based on the score, a summary of the nature-related impact of the organization on the ocean biomes. In some implementations, the causal discovery may be based on a framework that maps essential ocean variables to essential biodiversity variables. In some implementations, the server may enable, based on the quantified impacts, the organization to track and report its nature-related impacts and dependencies. In some implementations, the server may provide a dashboard or report that summarizes the organization's nature-related impacts and dependencies.

In some implementations, the server may extract metrics on the operations of an organization and map the metrics to a standardized template based on a sectoral assessment. The server may identify relevant ocean data from publicly available and proprietary data sources.

The server may translate the ocean data into variables that quantify effects on ocean biomes at different spatial levels. The server may attribute variations in the ocean data to specific activities of the organization based on a causal discovery. The server may generate reporting metrics and uncertainty on the identified activities. The sectoral assessment may consider geographical aspects, ocean biomes under influence, and sector-specific impacts of the organization operations. The causal discovery may use statistical or process-based models to assign fractional impacts on biodiversity or ecosystem functioning to sectors and actors. The server may perform scenario exploration to simulate different operational conditions and address data gaps and uncertainty. The server may generate a summary of the nature-related impact of the company on the pertinent ocean biomes, in a format of a report, dashboard, or natural language interface.

In some implementations, the server may attribute variations in ocean data to specific activities of a given organization based on sectoral assessment and industry operations on the ocean by a causal discovery. The sectoral assessment may include the extraction of metrics on the operations of the organization and the mapping of the metrics to a standardized template. The server may normalize data from diverse ocean and biodiversity metrics into a standardized index, which may allow for comparability across different biomes and industries. The normalizing may include inputting raw data from different sources into a mapping model that translates the raw data into key performance indicators (KPIs) and variables that are informative of biodiversity components of the ocean. The causal discovery may utilize machine learning models to attribute impacts to specific sectors or organizations, where impacts may include variations in ocean data.

In some implementations, by enabling the server to quantify nature-related impacts of the organization, the server may be able to efficiently process and analyze large amounts of ocean and operations data, thereby conserving processing resources, memory resources, and network resources. The server may also optimize data storage by transforming and storing data in a suitable format for analysis. The server may reduce computational overhead by identifying causal relationships and quantifying impacts, thereby enabling faster generation of reporting metrics and uncertainty on identified activities, thereby improving an overall system performance.

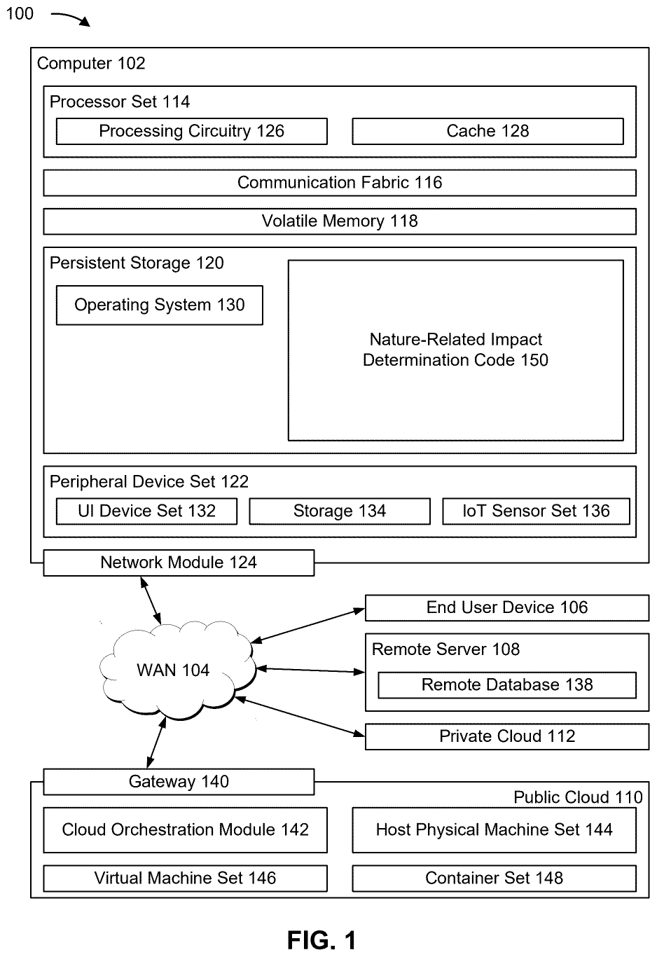

FIG. 1 is a diagram of an example computing environment 100 for identifying nature-related impacts of organizations.

The computing environment 100 contains an example of an environment for the execution of at least some of the computer code involved in performing the inventive methods, such as nature-related impact determination code 150. In addition to the nature-related impact determination code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the nature-related impact determination code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in nature-related impact determination code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the nature-related impact determination code 150 typically includes at least some of the computer code involved in performing one or more operations described herein. The operations may include, for example, identifying metrics associated with operations of an organization; identifying nature-related data associated with an ecosystem; providing the metrics and the nature-related data to a model; determining, based on the model, a nature-related impact of the organization, where the nature-related impact is based on a causal attribution that attributes a variation in the nature-related data to the operations of the organization; and generating a report that indicates the nature-related impact of the organization.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

Initiatives such as the taskforce on nature-related financial disclosures (TNFD) provide financial institutions and companies with frameworks to report and act on evolving nature-related risks. This can allow the impact of organization activities on the natural world, such as biodiversity loss, deforestation, and pollution, to be determined, as well as how the degradation of nature can impact financial markets. Shifting global financial flows toward nature-positive outcomes may be achieved by developing and promoting comprehensive, globally recognized standards for reporting nature-related risks and opportunities. Providing such a framework can enable organizations to assess, manage, and report their dependencies and impacts on nature, thereby helping to align financial flows with biodiversity goals and sustainable development. Organizations may include companies or businesses.

Within these frameworks, oceans can be a key focus due to their critical role in biodiversity, climate regulation, and ecosystem services. Therefore, companies and financial institutions can be encouraged to assess and disclose their impacts on oceans, considering risks like biodiversity loss, ocean acidification, and rising sea levels. Reporting frameworks can emphasize opportunities in sustainable ocean-related activities like sustainable fisheries and marine renewable energy. The goal can be to shift financial flows towards practices beneficial for ocean health, aligning with broader environmental and sustainability objectives.

Essential climate variables (ECVs) are a set of key variables for understanding and monitoring the Earth's climate system. ECVs may provide a metric for detecting and predicting climate change, assessing impacts, and supporting adaptation and mitigation strategies. Essential ocean variables (EOVs) are a set of key variables for understanding, monitoring, and managing ocean processes and marine life. EOVs may include physical parameters, biogeochemical parameters, and biological parameters, such as ocean temperature, salinity, and marine biodiversity. Essential biodiversity variables (EBVs) are a set of key measurements for studying, reporting, and managing biodiversity change. EBVs may be intended to provide a consistent framework for measuring biodiversity change over time and space, encompassing various aspects like species populations, ecosystem structure, and genetic diversity. A biome may refer to a large ecological area with distinctive types of marine life and environmental conditions. Ocean biomes may be primarily distinguished by factors such as water temperature, depth, nutrient availability, and light penetration. Such factors may influence the types of organisms that are able to thrive in each zone.

Numerous organizations have committed to reporting their nature-related impacts. The number of organizations that may be obligated to report their nature-related impacts is expected to grow in the coming years. However, organizations may not have a consumable methodology or system to report their impacts. Such a challenge may be particularly exacerbated in the oceans due to the scale of the problem, a sparse and fragmented ocean observation system, a lack of usability of satellite data since satellite may not penetrate after a certain ocean depth (which are key for terrestrial applications), and a large number of manners in which industries may impact oceans. For example, shipping may impact the oceans in terms of impacting coastal habitats, phytoplankton growth, migratory behaviour, ecosystem structure and extent, and/or species distribution. The impacts may vary greatly across different biomes or regions of the oceans from bays, estuaries, and coasts, to the open ocean. Organizations may lack a tool that allows to assess the sector or industry in which the organizations operate, assess and quantify their contributions/emissions/impacts within that sector, and assign the impacts of those operations to the operations of a given organization in a scientifically robust manner.

Organizations may not have suitable solutions for reporting their nature-related impacts, but rather may rely on highly manual processes. Reporting frameworks may utilize methodology to help organizations report the nature-related impacts. The methodology may rely on a process built on a leap, evaluate, assess, and prepare approach, which may assist organizations in assessing their nature-related risks and opportunities. Organizations may be encouraged to understand their interaction with nature, evaluate their dependencies and impacts, assess risks and opportunities, and prepare appropriate responses and reporting. The TNFD framework may focus on metrics and targets with respect to soil erosion, ocean plastics, and biodiversity.

With the increasing global focus on nature-related financial disclosures, organizations may be increasingly mandated to assess and report their impacts on freshwater and marine ecosystems. However, a major challenge is the lack of a standardized, scientifically robust methodology to quantify these impacts. The complexity may arise from the vast scale of oceanic systems, fragmented observational data, limited penetration of satellite monitoring in deep waters, and the diverse ways in which industries—such as shipping, fisheries, and energy affect marine environments. Organizations may lack a systematic approach to evaluate their industry-specific contributions, attribute their operations' effects to measurable ecological changes, and generate accurate, actionable reports.

In some implementations, a server (or multiple servers) may enable organizations to quantity their nature-related impacts and dependencies. The server may combine observations, machine learning, and causal discovery to quantify the impacts of industry operations on the ocean. Causal artificial intelligence may be used to attribute changes in environmental metrics to specific operations of an organization. The server may include or be associated with various components to help quantify the nature-related impacts and dependencies of the organization. A sectoral assessment component may extract metrics on the operations of an organization and map the metrics to a standardized template. The metrics and/or the operations may vary across sectors. For example, for fisheries, the metrics may include catch volume, types of fish caught, fishing techniques, fishing regions, fuel consumption, and/or emissions. Activities to reduce the impacts on nature may be relevant, such as investment in fishing techniques that minimize bycatch, ecosystem restoration activities such as coral reefs, or investment to reduce fish by-product. A data mapping component may have an ability to understand which data is required to report on biodiversity and ecosystem impacts, such as population structure, habitat structure, and ecosystem extents. Data understanding may be based on the sectoral assessment. A data transformation component may take ocean climate data, which may include EOVs and EBVs, and translate such data to metrics that quantify effects at different spatial levels of the ocean (or different ocean biomes). Data may be ingested from publicly available sources or from proprietary, targeted data sources. A causal discovery component may attribute variations in the ocean data to specific activities of a given organization. For example, for a fishery company, changes in ecosystem structure may be attributed to the specific fishing activities of the pertinent organization rather than impacts of the sector as a whole. A scenario exploration component may enable quantitative simulation of different operational conditions to generate reporting metrics and uncertainty on the identified activities and address data gaps.

In some implementations, the server may integrate observational data, machine learning, and causal discovery to quantify the environmental impacts of industrial activities on ocean ecosystems. The server may perform a sectoral assessment, which may analyze the organization's operations within its industry, extract relevant metrics, and map the relevant metrics to a standardized reporting framework. The sectoral assessment may ensure that impacts are assessed consistently across sectors. The server may perform a data mapping, which may identify key environmental variables required to evaluate biodiversity and ecosystem changes, such as population dynamics, habitat structure, and ecosystem extents. The data mapping may ensure that organizations use the most relevant and scientifically validated indicators for reporting. The server may perform a data transformation, which may convert raw ocean climate and biodiversity data (e.g., EOVs and EBVs) into quantifiable impact metrics. The data transformation may allow an assessment across different marine biomes, such as coastal waters or the deep ocean. The server may perform causal discovery and attribution, which may use machine learning and causal inference techniques to determine the extent to which observed variations in ocean conditions can be attributed to specific organization activities. The causal discovery and attribution may ensure that reports are based on scientifically grounded cause-and-effect relationships rather than simple correlations. The server may perform scenario exploration and simulation, which may enable organizations to model different operational scenarios, estimate potential environmental outcomes under various conditions, and quantify uncertainties in their impact assessments. The scenario exploration and simulation may support more informed decision-making and help to address data gaps.

In some implementations, the server may receive, as an input, a selection of a desired reporting framework, such as the TNFD framework, a global reporting initiative (GRI) framework, or a science based targets network (SBTN) framework. The server may receive, as an input, a data repository related to organization operations related to the ocean sector. For example, the data repository may include information regarding locations of operations, supply chains, or waste disposal relative to coastal and marine areas. The server may produce, as an output, a summary of a nature-related impact of the organization on the pertinent ocean biomes. The output may be in the format of a report, a dashboard, or a natural language interface.

In some implementations, the server may use generative artificial intelligence to assess organization-level impacts and to enable nature-related reporting. The server may produce output which includes quantitative metrics of the organization's nature-related impacts. By using causal attribution capabilities, the output may be fully auditable in terms of a manner in which sectoral assessment relates to nature impacts, which may inform on how different operations within each sector impact the organization's total nature impact. The server may be able to indicate dependencies on ecosystem services provided by marine environments, such as nutrient cycling, carbon sequestration, or food provision, and an understanding of how such activities may compromise these services.

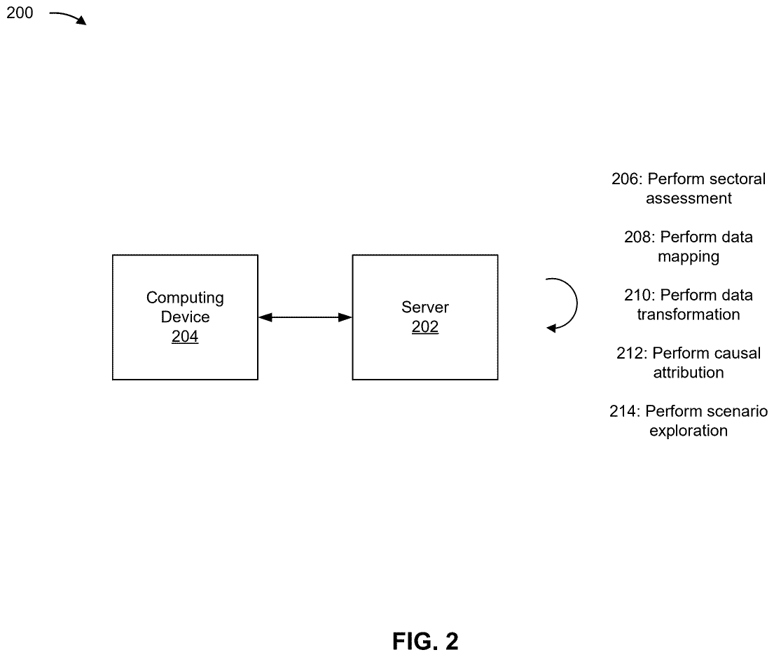

FIG. 2 is a diagram illustrating an example 200 associated with identifying nature-related impacts of organizations. The example 200 may include a server 202 and a computing device 204. The computing device 204 may be associated with an organization. The computing device 204 may be used to provide various types of input information, where the input information may be used by the server 202 in order to identify the nature-related impacts of organizations. The server 202 may provide an output to the computing device 204, where the output may be an indication of the nature-related impacts. The output may allow organizations to quantify and report the impacts of their activities on nature and biodiversity.

In some implementations, the server 202 may enable organizations to quantity their nature-related impacts and dependencies. The server 202 may combine observations, machine learning, and causal discovery to quantify the impacts of industry operations on the ocean. Causal artificial intelligence may be used to attribute changes in environmental metrics to specific operations of an organization. The server 202 may function to quantify the nature-related impacts and dependencies of the organization.

As shown by reference number 206, the server 202 may perform a sectoral assessment. As part of the sectoral assessment, the server 202 may extract metrics on the operations of an organization and map the metrics to a standardized template. The metrics and/or the operations may vary across sectors. For example, for fisheries, the metrics may include catch volume, types of fish caught, fishing techniques, fishing regions, fuel consumption, and/or emissions. Activities to reduce the impacts on nature may be relevant, such as investment in fishing techniques that minimize bycatch, ecosystem restoration activities such as coral reefs, or investment to reduce fish by-product. As part of the sectoral assessment, the server 202 may analyze the organization's operations within its industry, extract relevant metrics, and map the relevant metrics to a standardized reporting framework. The sectoral assessment may ensure that impacts are assessed consistently across sectors. The sectoral assessment may involve extracting organization-specific operational data (e.g., fishing methods, fuel consumption, or emissions) and mapping the organization-specific operational data to a standardized framework.

In some implementations, as part of the sectoral assessment, nature-related impacts may be decomposed based on sectors or industry, biomes, ocean regions, or biodiversity metrics. Different sectors may have an impact across different biomes. An impact of an organization across sectors and biomes may be impacted by factors like operations, supply chains, and geographical extents. The sectoral assessment may consider geographical aspects (e.g., locations of operations, supply chains, and waste disposal relative to coastal and marine locations). The sectoral assessment may consider specific ocean biomes (e.g., coral reefs, mangroves, open oceans, or coastal zones) that are within the areas of influence. The sectoral assessment may consider the impact of the organization's sector, such as transport or fisheries.

In some implementations, the sectoral assessment may involve using data sources for ocean-related impact. The data sources may be associated with geographical aspects. The geographical aspects may include a location of operations and supply chains. The location of operations and supply chains may map proximity to coastlines, ports, and shipping lanes. The geographical aspects may include waste disposal impact zones. The waste disposal impact zones may identify effluent discharge, plastic waste hotspots, and their effects on marine areas. The data sources may be associated with ocean biomes under influence. The ocean biomes under influence may include coral reefs, mangroves, coastal zones, or open oceans. An operations impact on diverse biomes may be assessed. Regions of high biodiversity or conservation value (e.g., marine protected areas) may be identified. The data sources may be associated with sector-specific impacts. The sector-specific impacts may include transport and shipping, which may be associated with the effects of ballast water discharge, noise pollution, and emissions. The sector-specific impacts may include fisheries and aquaculture, which may be associated with overfishing, habitat degradation, and bycatch. The sector-specific impacts may include agriculture and industry runoff, which may be associated with nutrient pollution and sedimentation affecting coastal waters. The sector-specific impacts may include energy and mining, which may be associated with offshore drilling and seabed mining disrupting marine habitats.

In some implementations, the server 202 may extract pertinent data as part of the sectoral assessment. The server 202 may perform geospatial analytics and mapping. The server 202 may use satellite data to correlate operations with sensitive marine regions. The server 202 may use large language models (LLMs) for text mining and summarization. The server 202 may use LLMs to scan extensive documents like sustainability reports, government regulations, or stakeholder feedback to identify and summarize relevant ocean-related impacts. The server 202 may extract industry insights. The server 202 may use LLMs to identify sectoral impacts (e.g., transport emissions or fisheries practices) from documents like industry reports, compliance documents, and news articles, which may allow for a deeper understanding of sector-specific marine impacts. The server 202 may perform an environmental data reporting. Environmental data (e.g., water usage) may be processed accordingly.

As shown by reference number 208, the server 202 may perform a data mapping. As part of the data mapping, the server 202 may aim to understand which data is required to report on biodiversity and ecosystem impacts, such as population structure, habitat structure, and ecosystem extents. Data understanding may be based on the sectoral assessment. As part of the data mapping, the server 202 may identify key environmental variables required to evaluate biodiversity and ecosystem changes, such as population dynamics, habitat structure, and ecosystem extents. The data mapping may ensure that organizations use the most relevant and scientifically validated indicators for reporting.

As shown by reference number 210, the server 202 may perform a data transformation. As part of the data transformation, the server 202 may take ocean climate data, which may include ocean variables and biodiversity variables (e.g., EOVs and EBVs), and translate such data to metrics that quantify effects at different spatial levels of the ocean (or different ocean biomes). Data may be ingested from publicly available sources or from proprietary, targeted data sources. As part of the data transformation, the server 202 may convert raw ocean climate and biodiversity data (e.g., EOVs and EBVs) into quantifiable impact metrics. The data transformation may allow an assessment across different marine biomes, such as coastal waters or the deep ocean. The data transformation may involve translating raw ocean climate data (e.g., EOVs and EBVs) into business-relevant impact metrics.

In some implementations, the sectoral assessment may indicate which data is needed to inform on an organization impact. As part of a data discovery, based on the sectors, the biomes, and/or geographical extents that are impacted by the organization, pertinent ocean data from publicly available sources may be gathered. Data gathered from the publicly available sources may be augmented with privately collected data. A framework may be leveraged to map EOVs, such as phytoplankton levels, macroalgal cover, and fish abundance, to EBVs that influence biome impacts. Emerging models for fisheries, pollution, and benthic habitats may be leveraged.

As shown by reference number 212, the server 202 may perform a causal attribution. As part of the causal attribution, the server 202 may attribute variations in the ocean data to specific activities of a given organization. For example, for a fishery company, changes in ecosystem structure may be attributed to the specific fishing activities of the pertinent organization rather than impacts of the sector as a whole. As part of the causal attribution, the server 202 may use machine learning and causal inference techniques to determine the extent to which observed variations in ocean conditions can be attributed to specific organization activities. The causal attribution may ensure that reports are based on scientifically grounded cause-and-effect relationships rather than simple correlations. The causal attribution may use artificial intelligence to explicitly attribute changes in ocean biodiversity, habitat structure, and ecosystem health to specific activities of a given organization.

In some implementations, the sectoral assessment and the data discovery may yield a potential impact type and variability. Causal attribution may assign an observed, or predicted, share of a total impact to individual sectors and organizations. Causal attribution may use statistical or process-based pressure-state models to assign impacts (or fractional impacts) on biodiversity or ecosystem functioning to sectors and actors. The causal attribution may assign the impact directly when stressors are concretely locatable in space and time (e.g., fishing with an automatic identification system (AIS)-equipped vessel). The causal attribution may assign the impact proportionally when stressors (or their operation) cannot be spatially-temporally tracked (e.g., industrial area discharging warm water into rivers). A model (or multiple models) may ingest past observed state variables (e.g., biodiversity, ecosystem functioning, and their mediators) and pressure data (e.g., type, location, time, and extent of operation). The model may identify functional relationships and parameter sets which provide the best hindcast (e.g., provide the best explanation of observed states, given other states and a pressor set). Once trained, the model (or their ensembles) may be used to quantify a predicted effect of a single organization's actions on changes in the state variables observed during operations. The model may be able to provide an inference on which observed changes can be plausibly assigned to which actions.

As shown by reference number 214, the server 202 may perform a scenario exploration. As part of the scenario exploration, the server 202 may enable quantitative simulation of different operational conditions to generate reporting metrics and uncertainty on the identified activities and address data gaps. As part of the scenario exploration and a simulation, the server 202 enable organizations to model different operational scenarios, estimate potential environmental outcomes under various conditions, and quantify uncertainties in their impact assessments. The scenario exploration and simulation may support more informed decision-making and help to address data gaps. The scenario exploration may enable organizations to simulate alternative operational decisions and assess their impact on the environment.

In some implementations, the scenario exploration may be optionally used to improve decision making. Based on the data and causal models developed, the server 202 may generate different scenario exploration pathways to help organizations improve their nature-related impacts, which may include improved data collection approaches or steps to reduce impacts. The server 202 may simulate operational conditions. The server 202 may create quantitative models for various operational scenarios (e.g., increased shipping or coastal expansion). The server 202 may evaluate an impact on reporting metrics. The server 202 may predict key environmental indicators (e.g., emissions or resource use) under different conditions. The server 202 may address data gaps and uncertainly. The server 202 may model data gaps. The server 202 may use simulations to fill in missing data for comprehensive analysis. The server 202 may quantify uncertainty. The server 202 may analyze and report on potential variance in environmental impact, which may improve transparency and accuracy.

FIG. 2 is provided as an example. Other examples may differ from what is described with regard to FIG. 2.

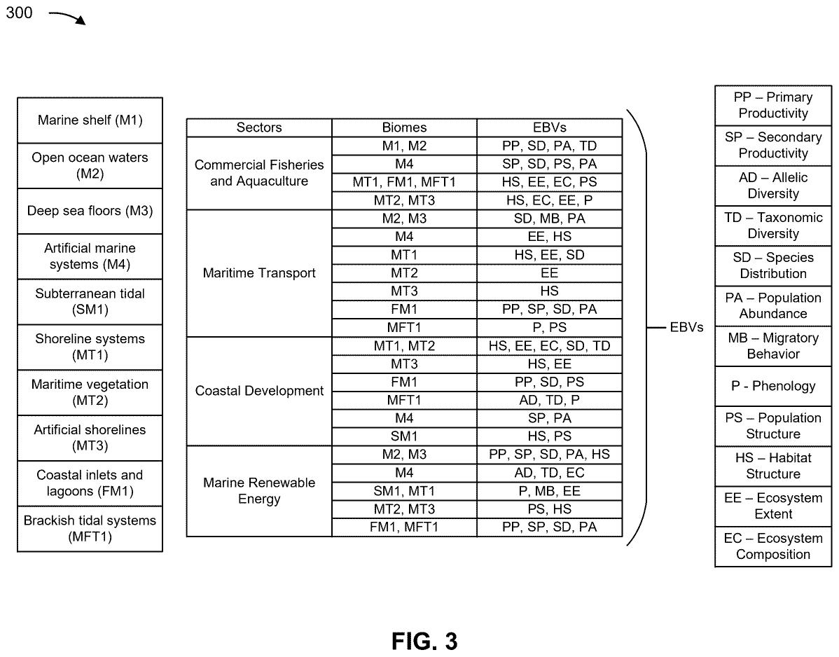

FIG. 3 is a diagram illustrating an example 300 associated with EBVs.

As shown in FIG. 3, different sectors may be associated with different biomes and different EBVs. Certain sectors may have an impact across the different biomes. The different sectors may include commercial fisheries and aquaculture, maritime transport, coastal development, and marine renewable energy. The biomes may include marine shelf (M1), open ocean waters (M2), deep sea floors (M3), artificial marine systems (M4), subterranean tidal (SM1), shoreline systems (MT1), marmite vegetation (MT2), artificial shorelines (MT3), coastal inlets and lagoons (FM1), and brackish tidal systems (MFT1). The EBVs may include primary productivity (PP), secondary productivity (SP), allelic diversity (AD), taxonomic diversity (TD), species distribution (SD), population distribution (PA), migratory behavior (MB), phenology (P), population structure (PS), habitat structure (HS), ecosystem extent (EE), and ecosystem composition (EC).

FIG. 3 is provided as an example. Other examples may differ from what is described with regard to FIG. 3.

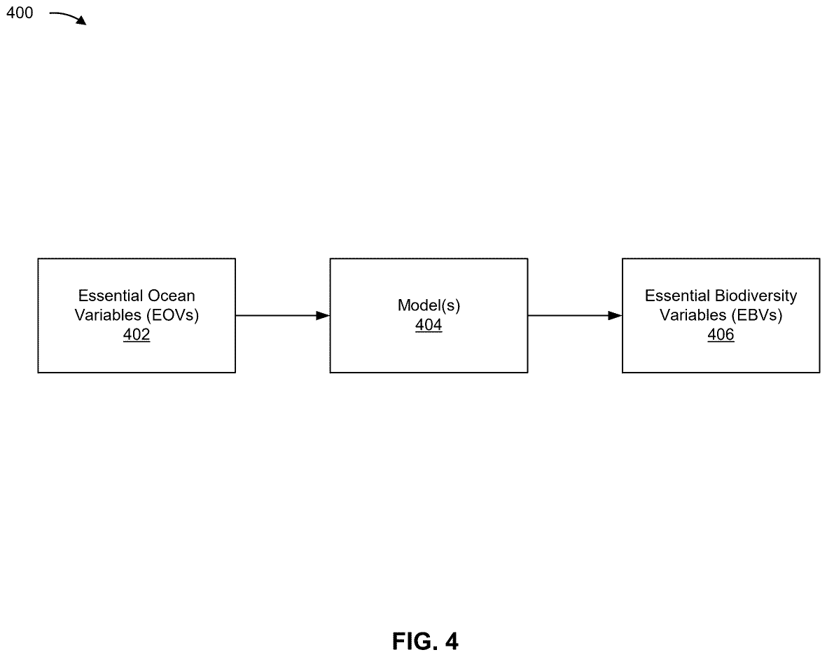

FIG. 4 is a diagram illustrating an example 400 associated with mapping EOVs and EBVs.

As shown in FIG. 4, one or more EOVs 402 may be mapped to one or more EBVs 406. A mapping between the one or more EOVs 402 and the one or more EBVs 406 may be based on one or more models 404, which may include biogeochemical models or graphical socio-ecological models. The one or more EOVs 402 may include microbe biomass and diversity, phytoplankton biomass and diversity, zooplankton biomass and diversity, benthic invertebrate abundance and distribution, fish abundance and distribution, macroalgal canopy cover and composition, seagrass cover and composition, hard coral cover and composition, or mangrove cover and composition. The one or more EBVs 406 may include primary productivity, secondary production, allelic diversity, taxonomic diversity, species distribution, population abundance migratory behavior, phenology, population structure by age/size class, habitat structure, ecosystem extent and fragmentation, or ecosystem composition and functional type.

FIG. 4 is provided as an example. Other examples may differ from what is described with regard to FIG. 4.

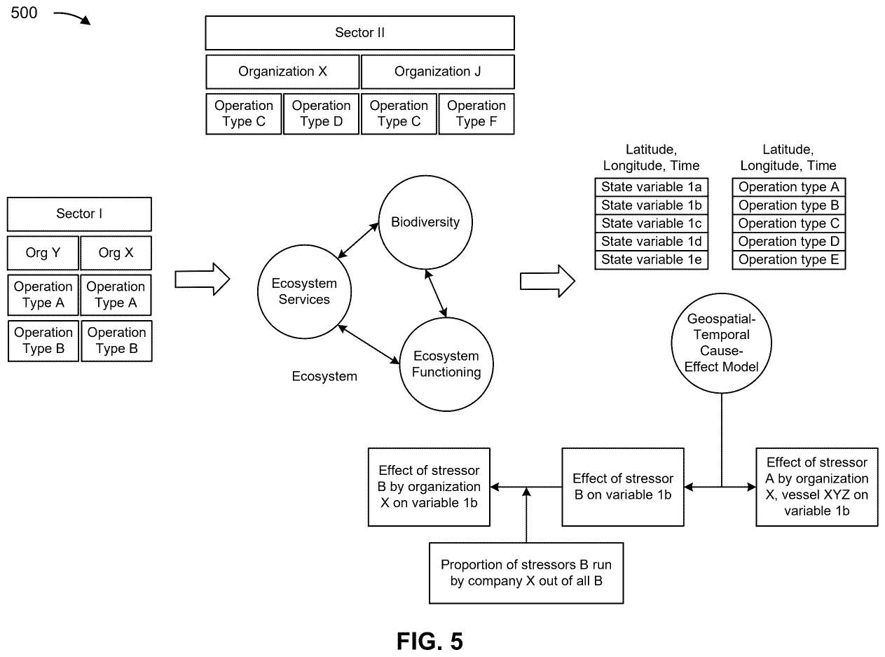

FIG. 5 is a diagram illustrating an example 500 associated with causal attribution.

As shown in FIG. 5, sector I may be associated with organization Y and organization X. Organization Y may be associated with operation type B and operation type A. Organization X may be associated with operation type B and operation type A. Sector II may be associated with organization X and organization J. Organization X may be associated with operation type C and operation type D. Organization J may be associated with operation type C and operation type F. Operation type A may be geo-temporally allocable. Operation type B may not be locatable in space and time. Operation type A may be associated with vessel XYZ. Operation type A may be associated with climate change, pollution, exploitation, or invasive species, which may have an impact on an ecosystem. The ecosystem may involve ecosystem services, biodiversity, and ecosystem functioning. A geospatial-temporal cause-effect model may identify a plurality of state variables and a plurality of operation types, which may each be associated with latitude information, longitude information, and time information. The geospatial-temporal cause-effect model may identify an effect of stressor A by organization X (e.g., vessel XYZ) on variable 1b. Stressor A may be associated with operation type A. The geospatial-temporal cause-effect model may identify an effect of stressor B on variable 1b. Stressor B may be associated with operation type B. The geospatial-temporal cause-effect model may identify an effect of stressor B by company X on variable 1b. The geospatial-temporal cause-effect model may identify a proportion of stressors B run by organization X out of all B. In this example, the geospatial-temporal cause-effect model may be used to perform causal attribution, which may involve assigning an observed or predicted share of a total impact to individual sectors and organizations.

FIG. 5 is provided as an example. Other examples may differ from what is described with regard to FIG. 5.

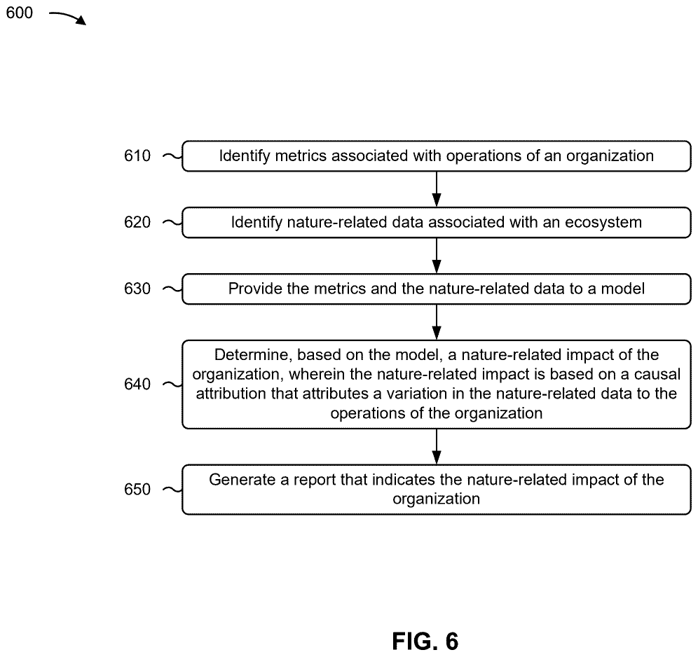

FIG. 6 is a flowchart of an example process 600 associated with identifying nature-related impacts of organizations. One or more process blocks of FIG. 6 are performed by a server (e.g., server 202) and/or by another device or a group of devices separate from or including the server.

As shown in FIG. 6, process 600 includes identifying metrics associated with operations of an organization (block 610). For example, the server may identify metrics associated with operations of an organization, as described above.

As further shown in FIG. 6, process 600 includes identifying nature-related data associated with an ecosystem (block 620). For example, the server may identify nature-related data associated with an ecosystem, as described above.

As further shown in FIG. 6, process 600 includes providing the metrics and the nature-related data to a model (block 630). For example, the server may provide the metrics and the nature-related data to a model, as described above.

As further shown in FIG. 6, process 600 includes determining, based on the model, a nature-related impact of the organization, wherein the nature-related impact is based on a causal attribution that attributes a variation in the nature-related data to the operations of the organization (block 640). For example, the server may determine, based on the model, a nature-related impact of the organization, wherein the nature-related impact is based on a causal attribution that attributes a variation in the nature-related data to the operations of the organization, as described above.

As further shown in FIG. 6, process 600 includes generating a report that indicates the nature-related impact of the organization (block 650). For example, the server may generate a report that indicates the nature-related impact of the organization, as described above.

Process 600 may include additional aspects, such as any single aspect or any combination of aspects described below and/or in connection with one or more other processes described elsewhere herein.

In a first aspect, process 600 includes converting the nature-related data to ocean variables, wherein the ocean variables are associated with quantifiable impact metrics.

In a second aspect, alone or in combination with the first aspect, process 600 includes converting the nature-related data to biodiversity variables, wherein the biodiversity variables are associated with quantifiable impact metrics.

In a third aspect, alone or in combination with one or more of the first and second aspects, the ecosystem is a marine ecosystem.

In a fourth aspect, alone or in combination with one or more of the first through third aspects, the model is a geospatial-temporal cause-effect model that uses one or more state variables associated with location information and time information.

In a fifth aspect, alone or in combination with one or more of the first through fourth aspects, the causal attribution assigns an observed or predicted share of a total impact to the organization.

In a sixth aspect, alone or in combination with one or more of the first through fifth aspects, the causal attribution uses statistical or process-based pressure-state models to assign fractional impacts on biodiversity and ecosystem functioning to the organization.

In a seventh aspect, alone or in combination with one or more of the first through sixth aspects, the model is used to quantify a predicted effect of the operations of the organization to changes in state variables observed during the operations, and wherein the changes in state variables are indicated by the nature-related data.

In an eighth aspect, alone or in combination with one or more of the first through seventh aspects, process 600 includes mapping the metrics to a standardized reporting framework.

In a ninth aspect, alone or in combination with one or more of the first through eighth aspects, process 600 includes providing a simulation that models an operational scenario and estimates potential environmental impacts under one or more conditions.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

In some implementations, a method comprises: identifying metrics associated with operations of an organization; identifying nature-related data associated with an ecosystem; providing the metrics and the nature-related data to a model; determining, based on the model, a nature-related impact of the organization, wherein the nature-related impact is based on a causal attribution that attributes a variation in the nature-related data to the operations of the organization; and generating a report that indicates the nature-related impact of the organization.

In some implementations, the method further comprises: converting the nature-related data to ocean variables, wherein the ocean variables are associated with quantifiable impact metrics.

In some implementations, the method further comprises: converting the nature-related data to biodiversity variables, wherein the biodiversity variables are associated with quantifiable impact metrics.

In some implementations, the ecosystem is a marine ecosystem.

In some implementations, the model is a geospatial-temporal cause-effect model that uses one or more state variables associated with location information and time information.

In some implementations, the causal attribution assigns an observed or predicted share of a total impact to the organization.

In some implementations, the causal attribution uses statistical or process-based pressure-state models to assign fractional impacts on biodiversity and ecosystem functioning to the organization.

In some implementations, the model is used to quantify a predicted effect of the operations of the organization to changes in state variables observed during the operations, and wherein the changes in state variables are indicated by the nature-related data.

In some implementations, the method further comprises: mapping the metrics to a standardized reporting framework.

In some implementations, the method further comprises: providing a simulation that models an operational scenario and estimates potential environmental impacts under one or more conditions.

In some implementations, a computer system comprises: a processor set; one or more computer-readable storage media; and program instructions stored on the one or more computer-readable storage media to cause the processor set to perform operations comprising: identifying metrics associated with operations of an organization; identifying nature-related data associated with a marine ecosystem; determining, using a model, a nature-related impact of the organization based on the metrics and the nature-related data, wherein the nature-related impact is based on a causal attribution that attributes a variation in the nature-related data to the operations of the organization; and generating a report that indicates the nature-related impact of the organization.

In some implementations, the operations further comprise: converting the nature-related data to ocean variables or biodiversity variables, wherein the ocean variables or the biodiversity variables are associated with quantifiable impact metrics.

In some implementations, the model is a geospatial-temporal cause-effect model that uses one or more state variables associated with location information and time information.

In some implementations, the causal attribution assigns an observed or predicted share of a total impact to the organization, and wherein the causal attribution uses statistical or process-based pressure-state models to assign fractional impacts on biodiversity and ecosystem functioning to the organization.

In some implementations, the model is used to quantify a predicted effect of the operations of the organization to changes in state variables observed during the operations, and wherein the changes in state variables are indicated by the nature-related data.

In some implementations, a computer program product comprises: one or more computer-readable storage media; and program instructions stored on the one or more computer-readable storage media to perform operations comprising: identifying metrics associated with operations of an organization; identifying nature-related data associated with a marine ecosystem; determining a nature-related impact of the organization based on the metrics and the nature-related data, wherein the nature-related impact is based on a causal attribution that attributes a variation in the nature-related data to the operations of the organization; and generating an output associated with the nature-related impact of the organization.

In some implementations, the operations further comprise: using a model to determine the nature-related impact of the organization, wherein the model is a geospatial-temporal cause-effect model that uses one or more state variables associated with location information and time information.

In some implementations, the causal attribution assigns an observed or predicted share of a total impact to the organization, and wherein the causal attribution uses statistical or process-based pressure-state models to assign fractional impacts on biodiversity and ecosystem functioning to the organization.

In some implementations, the operations further comprise: mapping the metrics to a standardized reporting framework; or providing a simulation that models an operational scenario and estimates potential environmental impacts under one or more conditions.

In some implementations, the output is associated with a report, a dashboard, or a natural language interface.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
receiving, as input, a selection of a standardized reporting framework and a data repository related to operations of an organization;
identifying metrics associated with the operations of the organization;
mapping the metrics to the selected standardized reporting framework;
identifying nature-related data associated with an ecosystem;
converting the nature-related data to one or more nature-related variables that are associated with quantifiable impact metrics;
providing the metrics and the one or more nature-related variables to a model;
determining, based on the model, a nature-related impact of the organization, wherein the nature-related impact is based on a causal attribution that attributes a variation in the nature-related data to the operations of the organization; and
generating, based on the mapping of the metrics to the selected standardized reporting framework, a report that indicates the nature-related impact of the organization.

2. The method of claim 1, wherein the one or more nature-related variables are ocean variables.

3. The method of claim 1, wherein the one or more nature-related variables.

4. The method of claim 1, wherein the ecosystem is a marine ecosystem.

5. The method of claim 1, wherein the model is a geospatial-temporal cause-effect model that uses one or more state variables associated with location information and time information.

6. The method of claim 1, wherein the causal attribution assigns an observed or predicted share of a total impact to the organization.

7. The method of claim 1, wherein the causal attribution uses statistical or process-based pressure-state models to assign fractional impacts on biodiversity and ecosystem functioning to the organization.

8. The method of claim 1, wherein the model is used to quantify a predicted effect of the operations of the organization to changes in state variables observed during the operations, and wherein the changes in state variables are indicated by the nature-related data.

9. (canceled)

10. The method of claim 1, further comprising:
providing a simulation that models an operational scenario and estimates potential environmental impacts under one or more conditions.

11. A computer system comprising:
a processor set;
one or more computer-readable storage media; and
program instructions stored on the one or more computer-readable storage media to cause the processor set to perform operations comprising:
receiving, as input, a selection of a standardized reporting framework and a data repository related to operations of an organization;
identifying metrics associated with the operations of the organization;
mapping the metrics to the standardized reporting framework;
identifying nature-related data associated with a marine ecosystem;
converting the nature-related data to one or more nature-related variables that are associated with quantifiable impact metrics;
determining, using a model, a nature-related impact of the organization based on the metrics and the one or more nature-related variables, wherein the nature-related impact is based on a causal attribution that attributes a variation in the nature-related data to the operations of the organization; and
generating, based on the mapping of the metrics to the standardized reporting framework, a report that indicates the nature-related impact of the organization.

12. The computer system of claim 11, wherein the
one or more nature-related variables are ocean variables or biodiversity variables.

13. The computer system of claim 11, wherein the model is a geospatial-temporal cause-effect model that uses one or more state variables associated with location information and time information.

14. The computer system of claim 11, wherein the causal attribution assigns an observed or predicted share of a total impact to the organization, and wherein the causal attribution uses statistical or process-based pressure-state models to assign fractional impacts on biodiversity and ecosystem functioning to the organization.

15. The computer system of claim 11, wherein the model is used to quantify a predicted effect of the operations of the organization to changes in state variables observed during the operations, and wherein the changes in state variables are indicated by the nature-related data.

16. A computer program product comprising:
one or more computer-readable storage media; and
program instructions stored on the one or more computer-readable storage media to perform operations comprising:
receiving, as input, a selection of a standardized reporting framework and a data repository related to operations of an organization;
identifying metrics associated with the operations of the organization;
mapping the metrics to the standardized reporting framework;
identifying nature-related data associated with an ecosystem;
converting the nature-related data to one or more nature-related variables that are associated with quantifiable impact metrics;
determining a nature-related impact of the organization based on the metrics and the one or more nature-related variables, wherein the nature-related impact is based on a causal attribution that attributes a variation in the nature-related data to the operations of the organization; and
generating, based on the mapping of the metrics to the standardized reporting framework, an output associated with the nature-related impact of the organization.

17. The computer program product of claim 16, wherein the operations further comprise:
using a model to determine the nature-related impact of the organization, wherein the model is a geospatial-temporal cause-effect model that uses one or more state variables associated with location information and time information.

18. The computer program product of claim 16, wherein the causal attribution assigns an observed or predicted share of a total impact to the organization, and wherein the causal attribution uses statistical or process-based pressure-state models to assign fractional impacts on biodiversity and ecosystem functioning to the organization.

19. The computer program product of claim 16, wherein the operations further comprise:
providing a simulation that models an operational scenario and estimates potential environmental impacts under one or more conditions.

20. The computer program product of claim 16, wherein the output is associated with a report, a dashboard, or a natural language interface.

21. The method of claim 1, wherein identifying metrics associated with the operations of the organization, comprises:
simulating different operational conditions to address data gaps;
quantifying uncertainty associated with the nature-related impact; and
generating reporting metrics based on the simulating and the uncertainty.
